(19) United States
(12) Patent Application Publication
(10) Pub. No.: US 2008/0237077 A1
(43) Pub. Date: Oct. 2, 2008

(54) Portfolio carrier construction

(76) Inventor: Eric Sage, Mamaroneck, NY (US)

Correspondence Address: LAW OFFICE OF LEO ZUCKER, 2591 Duning Drive, PO BOX 1177, Yorktown Heights, NY, 10598, US

(21) Appl. No.: 11/880,511

(22) Filed: Jul. 23, 2007

Related U.S. Application Data
(60) Provisional application No. 60/832,683, filed on Jul. 21, 2006.

(51) Int. Cl. B65D 85/62; B31B 1/25; B65D 5/43; B65D 5/46

(52) U.S. Cl. 206/425; 220/230; 220/771; 493/160

(57) ABSTRACT

A portfolio carrier constructed from a sheet material having central, left and right side portions. Score lines in the material define a pair of central panels with a separator panel, five right side panels, and five left side panels. The carrier is formed by (i) urging the major panels toward one another about score lines bounding the separator panel, (ii) urging the right side portion toward the central portion about a first score line, and folding the right side panels so that a middle panel forms a right side wall of the carrier, and remaining panels extend inward to define one or more interior compartments of the carrier, and (iii) urging the left side portion toward the central portion about a second score line, and folding the left side panels so that a middle panel forms a left side wall of the carrier, and remaining panels extend inward to define the compartments.

### CROSS REFERENCE TO RELATED APPLICATION

This application claims priority under 35 U.S.C. § 119(e) of U.S. Provisional Patent Application No. 60/832,683 filed Jul. 21, 2006, and entitled “Unitary Folder or Portfolio Construction”.

### BACKGROUND OF THE INVENTION

1. Field of the Invention

The present invention relates to portfolio carriers or folders that are manufactured from paperboard or like material.

2. Discussion of the Known Art

File boxes or cartons formed by folding a sheet of cardboard at pre-scored lines in a certain sequence, are generally known. For example, U.S. Pat. No. 1,299,503 (Apr. 8, 1919) discloses a paper box formed from a single piece of material which is folded or creased into form. The box is in the shape of a grip or satchel intended for holding small quantities of goods such as candy. Handles are formed integrally with the box walls. U.S. Pat. No. 1,876,982 (Sep. 13, 1932) also discloses a handle box made from a piece of sheet material such as paper or cardboard that is creased or scored.

Further, U.S. Pats. No. 3,955,749 (May 11, 1976); No. 4,243,171 (Jan. 6, 1981); and No. 3,073,508 (Jan. 15, 1963) describe expansible or collapsible carriers formed from a blank of cardboard. U.S. Pat. No. 4,863,093 (Sep. 5, 1989) discloses a decorative portfolio-presentation folder having a front cover that can be decorated using standard office equipment or by hand, and U.S. Pat. No. 6,612,771 (Sep. 2, 2003) shows a looseleaf binding device with a pair of mating fasteners for closing the device.

See also, U.S. Pats. No. 2,379,665 (Jul. 3, 1945), No. 1,864,069 (Jun. 21, 1932), and No. 4,734,288 (Mar. 29, 1988); and U.S. Patent Application Pub. No. 2002/0164088 (Nov. 7, 2002).

As far as is known, a portfolio carrier constructed by cutting, scoring, and folding a sheet of paperboard or like material in such a manner as to form one or more interior compartments for keeping papers or files separate from one another when carried in the portfolio, has not been publicly proposed or offered commercially.

### SUMMARY OF THE INVENTION

According to the invention, a portfolio carrier is constructed a sheet material having a central portion, a left side portion and a right side portion. The material has a number of score lines wherein a first score line defines a boundary between the central portion and the right side portion, and a second score line defines a boundary between the central portion and the left side portion. Score lines in the central portion define a pair of major panels and a separator panel extending between the major panels. Score lines in the right side portion define five right side panels, and score lines in the left side portion define five left side panels.

The score lines are configured so that the portfolio carrier is formed by (i) urging the pair of major panels toward one another about corresponding score lines defining opposite sides of the separator panel, (ii) urging the right side portion toward the central portion of the material about the first score line, and folding the right side panels over one another so that a middle one of the panels forms a right side wall of the carrier, and remaining right side panels extend inward partially to define one or more interior compartments of the carrier, and (iii) urging the left side portion toward the central portion about the second score line, and folding the left side panels over one another so that a middle one of the panels forms a left side wall of the carrier, and remaining left side panels extend inward partially to define the interior compartments.

For a better understanding of the invention, reference is made to the following description taken in conjunction with the accompanying drawing and the appended claims.

### BRIEF DESCRIPTION OF THE DRAWING

In the drawing:

FIG. 1 is a plan view of a sheet material that is cut and scored to define panels and other parts of a portfolio carrier according to a first embodiment of the invention;

FIG. 2 shows typical dimensions defining cuts and score lines on the sheet material in FIG. 1;

FIG. 3 is a view similar to FIG. 1, wherein two of the panels are folded to form handle portions of the portfolio carrier;

FIG. 4 is a plan view of a sheet material that is cut and scored to define panels and other parts of a portfolio carrier according to a second embodiment of the invention;

FIG. 5 shows typical dimensions defining cuts and score lines on the sheet material in FIG. 4;

FIG. 6 is a view similar to FIG. 4, wherein two of the panels are folded to form handle portions of the portfolio carrier;

FIG. 7 shows the first embodiment of FIG. 1 with certain panels folded and glued to one another, and with the portfolio carrier in a partially open position to illustrate the formation of side walls of the carrier;

FIG. 8 shows the second embodiment of FIG. 4 with certain panels folded and glued to one another, and with the portfolio carrier in a partially open position to illustrate the formation of side walls of the carrier;

FIG. 9 is a perspective view of the inventive portfolio carrier when fully closed;

FIG. 10 is an end view of the first embodiment of FIG. 1 when the portfolio carrier is in a partially open position;

FIG. 11 is an end view of the second embodiment of FIG. 4 when the portfolio carrier is in a partially open position;

FIG. 12 is front elevation view of the portfolio carrier when fully closed;

FIG. 13 is a plan view of a sheet material that is cut and scored to define panels and other parts of a portfolio carrier according to a third embodiment of the invention;

FIG. 14 shows typical dimensions defining cuts and score lines on the sheet material in FIG. 13;

FIG. 15 is a view similar to FIG. 13, showing an accordion folder mounted in an interior compartment of the carrier;

FIG. 16 shows the carrier of FIG. 15 in a partially open position;

FIG. 17 shows a closure system for the carrier of FIG. 15;

FIG. 18 is a plan view of a sheet material that is cut and scored to define panels and other parts of a portfolio carrier according to a fourth embodiment of the invention; and

FIG. 19 shows the carrier of FIG. 18 in a partially open position.

### DETAILED DESCRIPTION OF THE INVENTION

The present invention concerns a portfolio carrier that is constructed by folding a pre-cut sheet of paperboard, cardboard or like material in a certain sequence about defined score lines. When so folded, the sheet forms outside walls, interior dividers, and a handle for the portfolio. Magnetic or other closure devices are preferably provided on the panels that form the carrier handle.

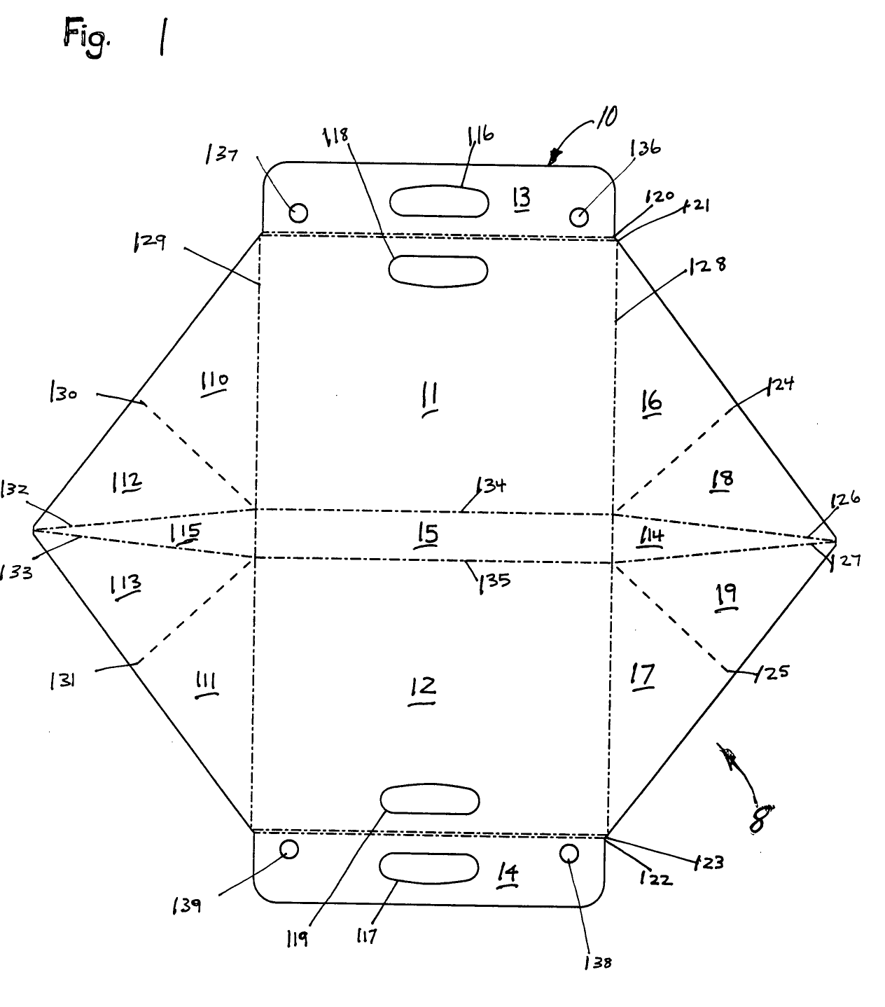

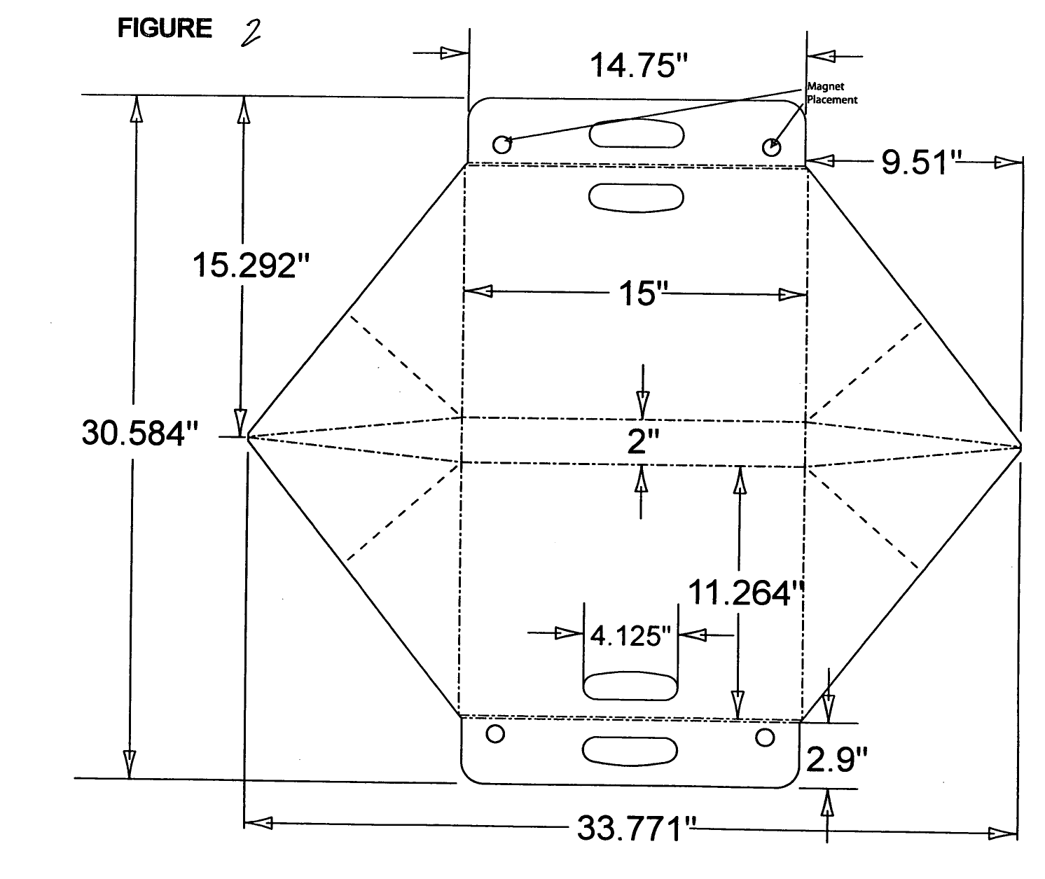

FIG. 1 shows a first embodiment of a portfolio carrier 8 according to the invention. A sheet material 10, for example, a sturdy paper corrugate, is cut to form outside edges and handle openings 116, 118 and 117, 119 in the material, as shown in dark lines in FIG. 1. Score lines, shown in dashed lines in the drawing, are also formed in the sheet material 10. The score lines serve to define various panels and handle portions of the portfolio carrier 8, including three interior compartments for keeping papers and/or other items separate from one another inside the carrier as described below. FIG. 2 shows an example of typical dimensions (in inches) defining the edges of the cut sheet material 10 and the score lines, and the placement of magnetic or other closure devices 136, 137, and 138, 139 (FIG. 1) on the material.

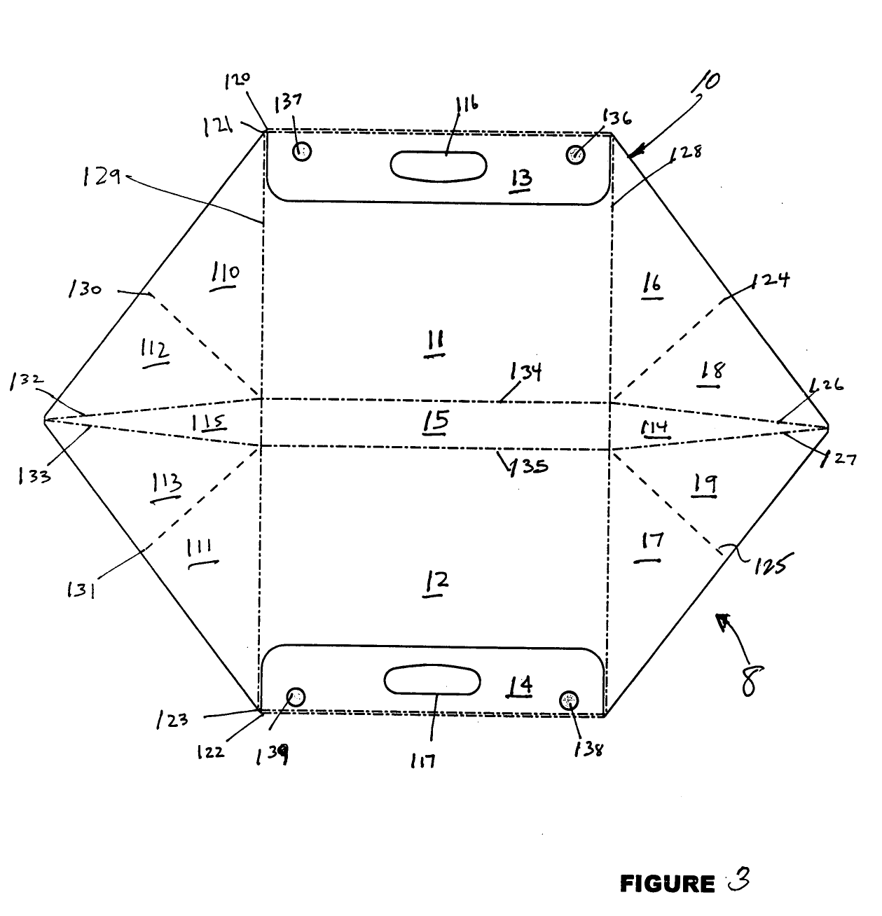

Basically, referring to FIGS. 1 and 3, the portfolio carrier 8 is formed with three interior compartments by folding right side panels 16, 18, 114, 19, and 17 inward along corresponding score lines 124, 125, 126, 127 and 128; and folding left side panels 110, 112, 115, 113, and 111 inward along corresponding score lines 129, 130, 131, 132 and 133 in a certain sequence as set out in the Example below. Panel 11 at the top half of FIGS. 1 and 3 forms one major wall of a first interior compartment of the portfolio carrier 8, for containing papers of files between the panel 11 and an interior wall formed by the folded-in panels 16 and 110.

A second interior compartment for containing papers or files inside the portfolio carrier 8, is defined between interior walls that are formed when folding in the opposed panels 18 and 112, and the opposite side panels 19 and 113. And a third interior compartment for containing papers or files inside the carrier 8 is defined between panel 12 (lower half of FIGS. 1 and 3) and an interior wall formed by the folded-in, opposite side panels 17 and 111.

FIG. 3 also shows a handle portion panel 13 after folding inward about close parallel score lines 120, 121 (see also FIG. 1) and being glued or otherwise fixed to the to the panel 11; and an opposite handle portion panel 14 after folding inward about close parallel score lines 122, 123 (see also FIG. 1) and being adhered to the panel 12.

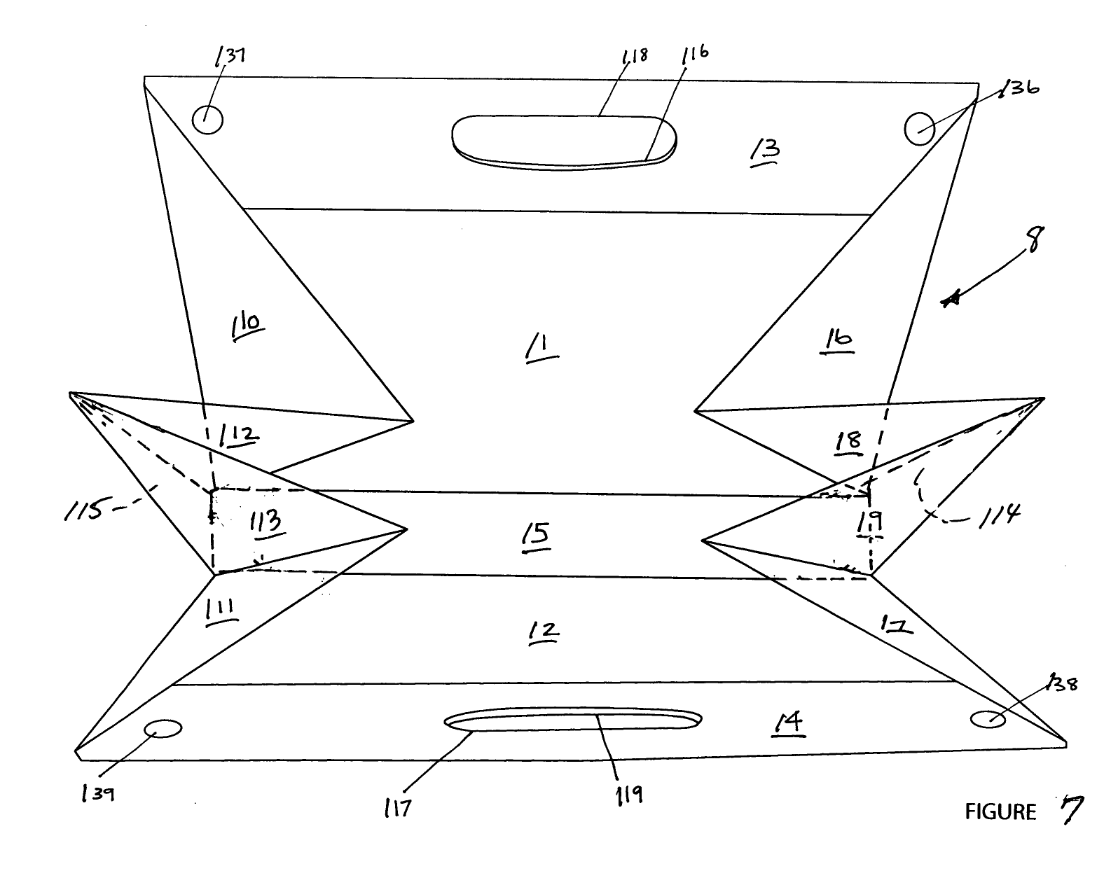

FIG. 7 shows the portfolio carrier 8 of FIG. 1 in a half open position with the panels 13, 14 folded in and fixed against the panels 11, 12 to form opposed handle portions for the carrier, and illustrates the formation of the three interior compartments. As mentioned, the first interior compartment is formed between the major panel 11 and an interior wall formed when the opposite side panels 16 and 110 are folded inward toward one another. The second interior compartment is defined between walls formed between the folded-in side panels 18, 112 and 19, 113. The third interior compartment is defined between the major panel 12, and a wall formed when the opposite side panels 17 and 111 are folded inward toward one another. Further, FIG. 7 shows that as the portfolio carrier 8 closes, the scored right-side panels 16, 18, 114, 19 and 17 fold accordion-like onto one another, and the scored left-side panels 110, 112, 115, 113 and 111 fold accordion-like onto one another. The magnets 136, 137 in the first handle portion confront the magnets 138, 139 in the confronting second handle portion and, thus, provide a secure closure system for the portfolio carrier.

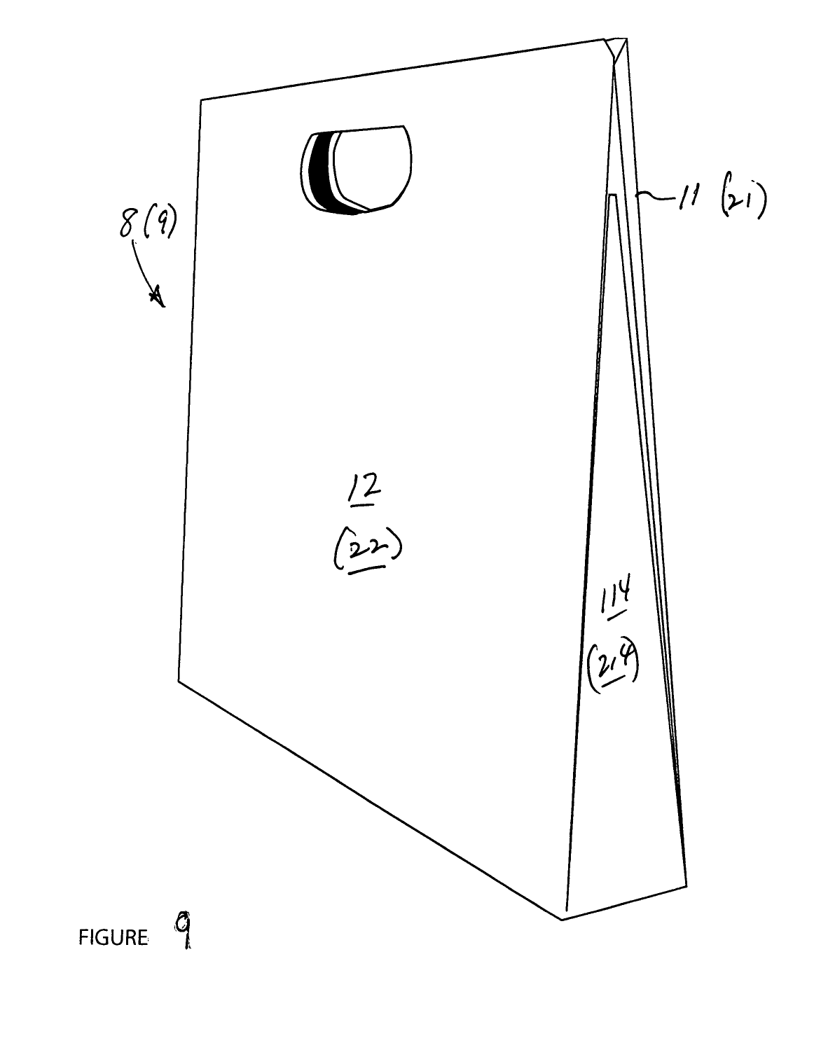

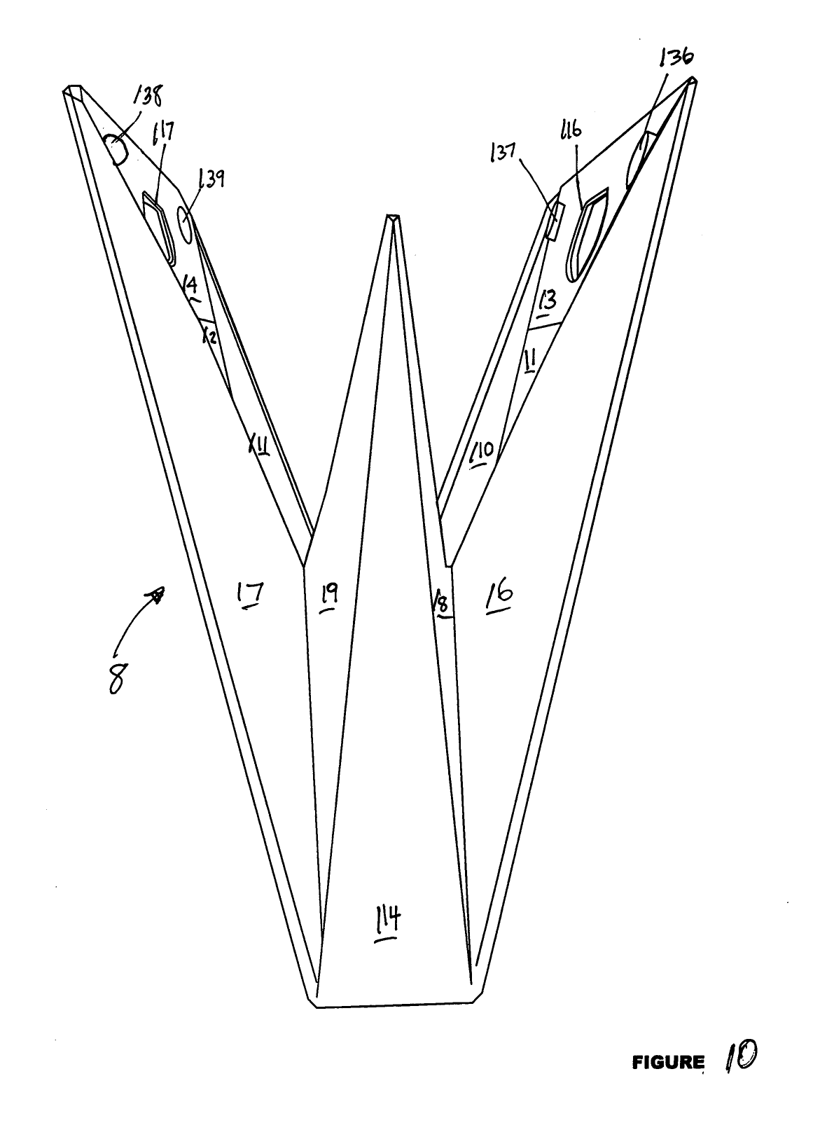

FIG. 10 is a side view of the portfolio carrier 8 in a partially open position, and FIG. 9 is a perspective view of the carrier when in a fully closed position. As seen in FIG. 9, the middle right and the middle left side panels 114, 115 form the side walls of the closed portfolio carrier 8.

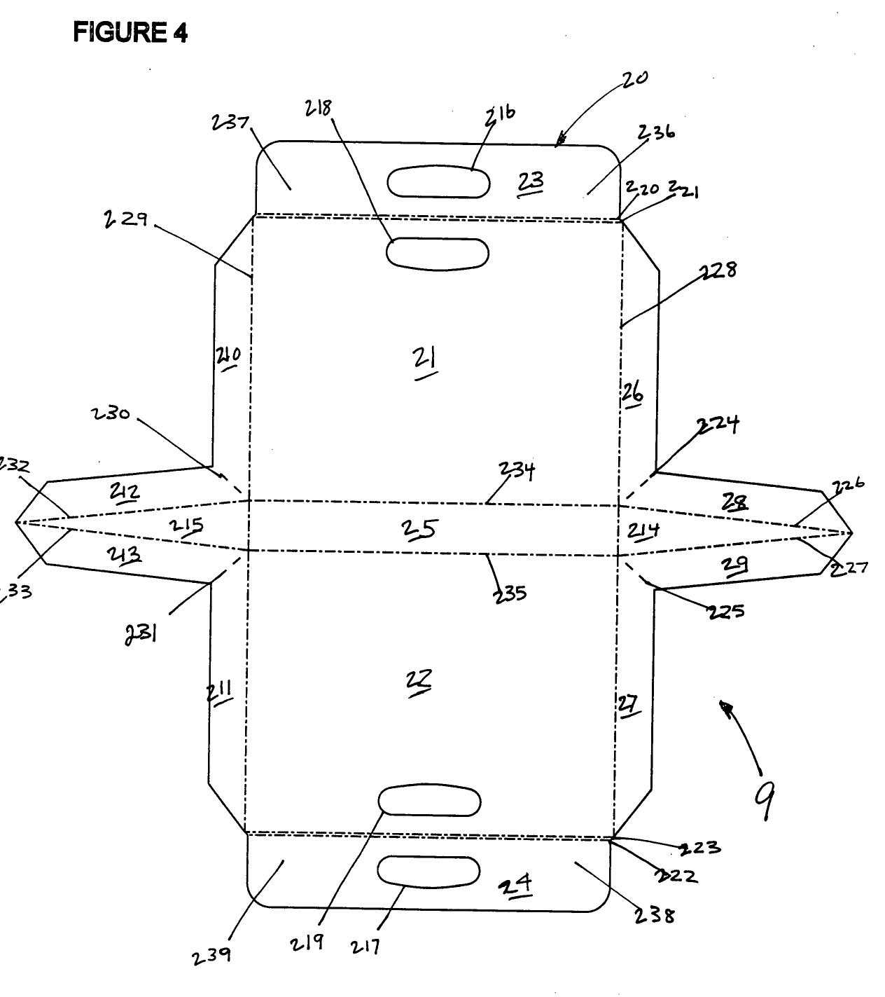

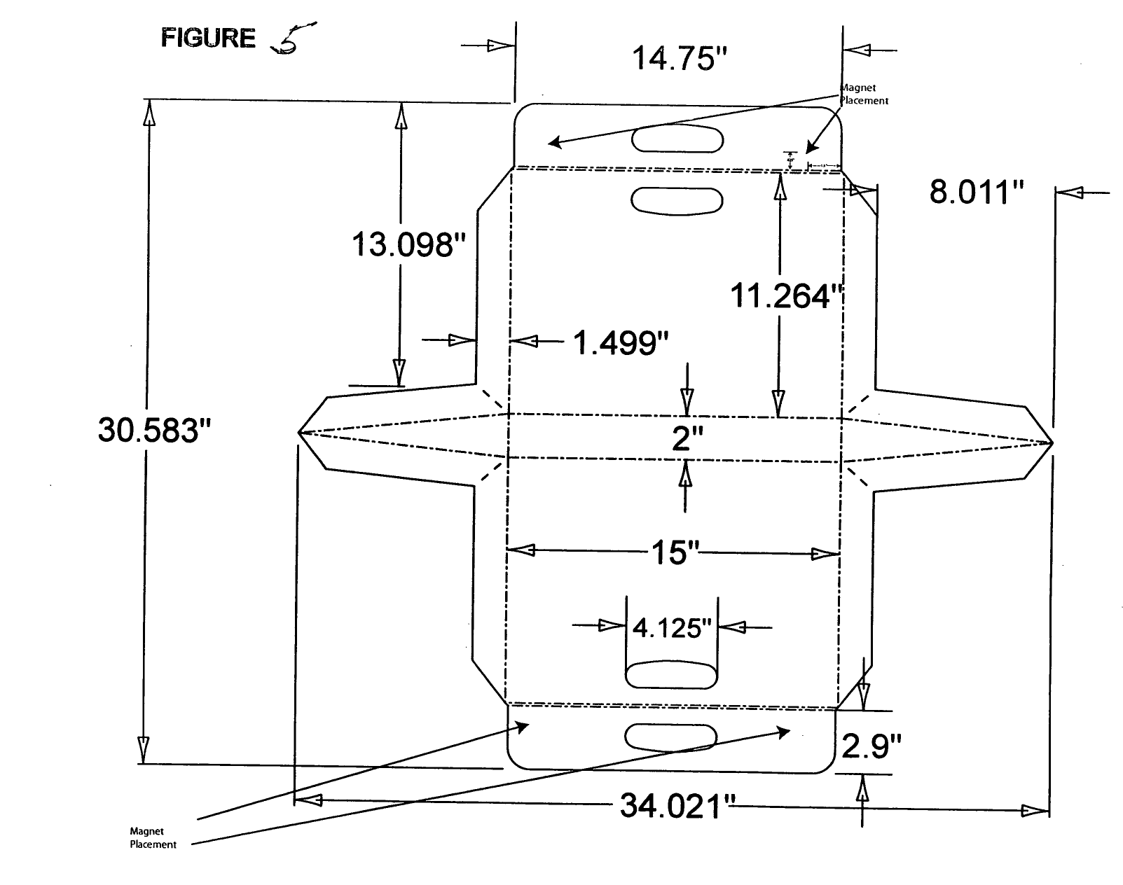

FIG. 4 shows a second embodiment of a portfolio carrier 9 according to the invention. A sheet material 20, for example, a sturdy paper corrugate, is cut to form outside edges and handle openings 216, 218 and 217, 219 in the material, as shown in dark lines in FIG. 4. Score lines, shown in dashed lines in the drawing, are also formed in the sheet material 20. The score lines serve to define various panels and handle portions of the portfolio carrier 9, including three interior compartments and, optionally, a central compartment, for containing papers and/or other items inside the carrier as described below. FIG. 5 shows an example of typical dimensions (in inches) defining the edges of the cut sheet material 20 and the score lines, and the placement of magnetic or other closure devices 236, 237 and 238, 239 (FIG. 4) on the material.

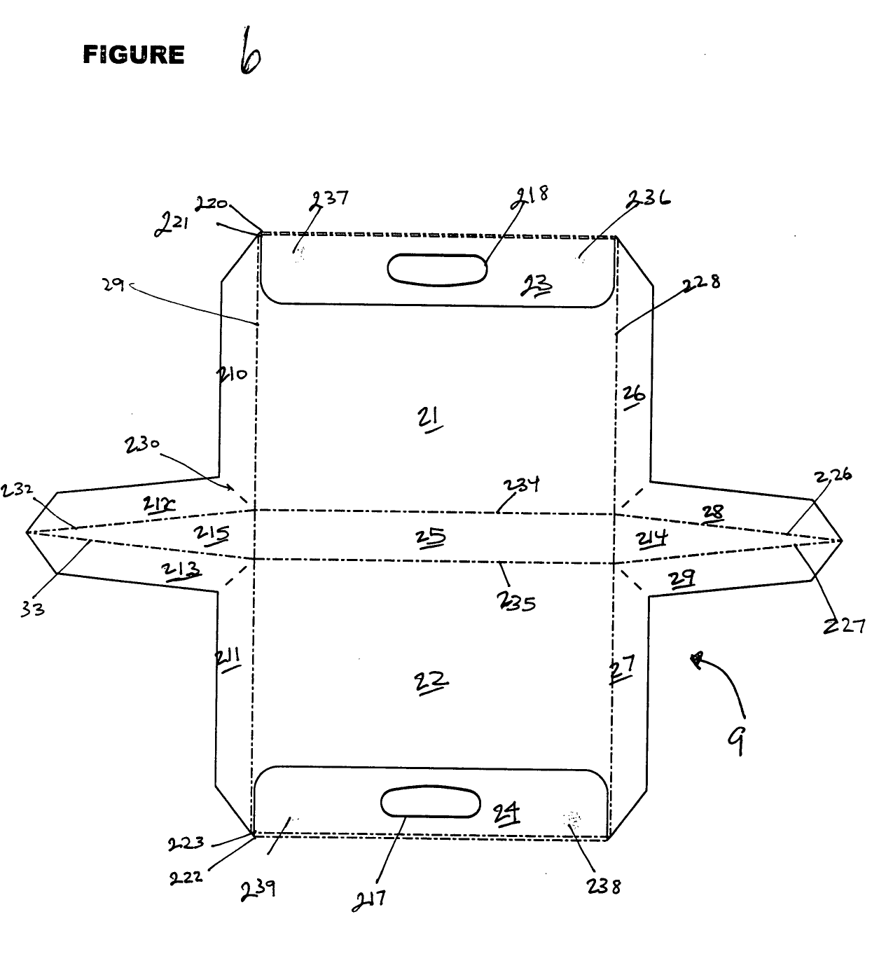

Basically, referring to FIGS. 4 and 6, the portfolio carrier 9 is formed with three interior compartments and an optional central compartment by folding right side panels 26, 28, 214, 29, and 27 inward along corresponding score lines 224, 225, 226, 227 and 228; and by folding left side panels 210, 212, 215, 213, and 211 inward along corresponding score lines 229, 230, 231, 232 and 233. Smaller papers and other items may optionally be contained together in the central compartment, which is defined by the panels 21, 22 and the free edges of the right and the left side panels when the side panels are folded inward.

FIG. 6 also shows a handle portion panel 23 after folding inward about close parallel score lines 220, 221 (see also FIG. 4) and being glued or otherwise fixed to the to the panel 21; and an opposite handle portion panel 24 after folding inward about close parallel score lines 222, 223 (see FIG. 1) and being adhered to the panel 22.

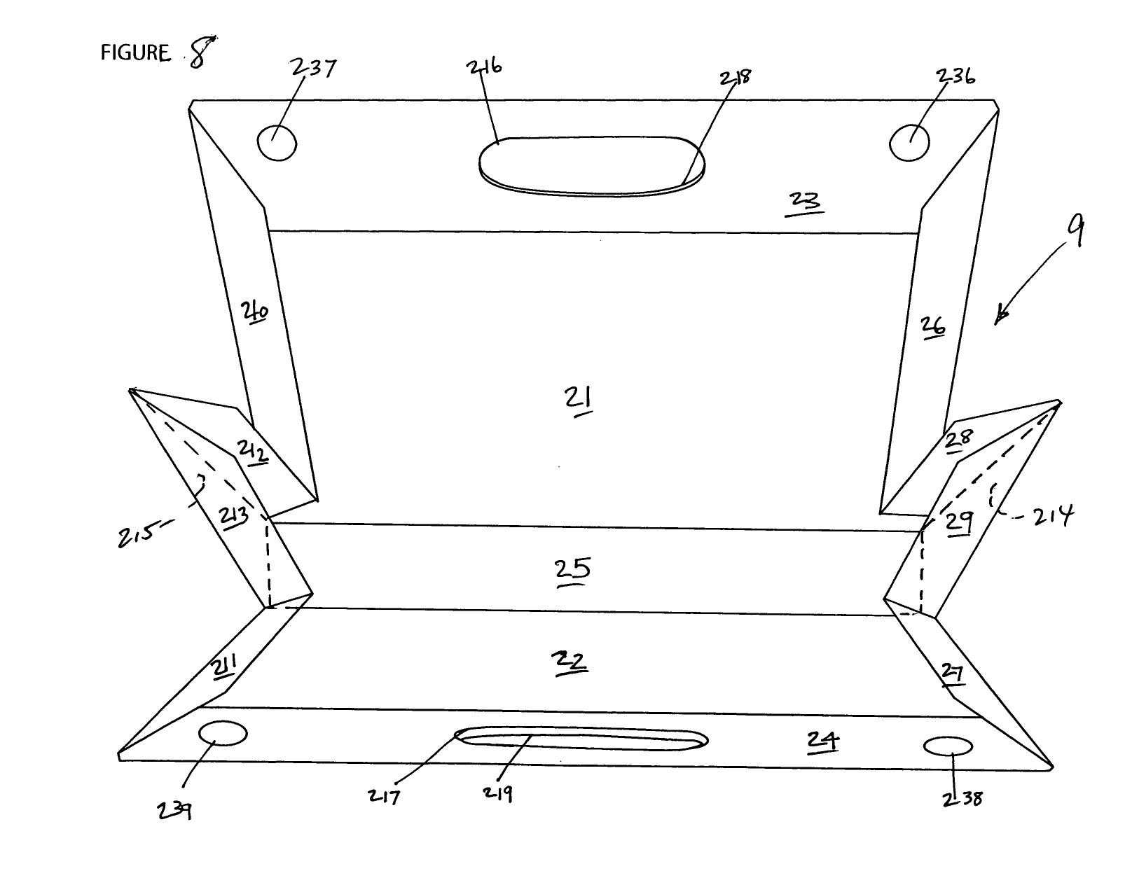

FIG. 8 shows the portfolio carrier 9 of FIG. 4 in a half open position with the panels 23, 24 folded in and fixed against the panels 21, 22 to form opposed handle portions for the carrier, and illustrates the formation of the side walls of the carrier. Specifically, when the scored right side panels 26, 28, 214, 29 and 27 in FIG. 8 are folded inward, the middle panel 214 forms a right side wall of the portfolio carrier 9. When the scored left side panels 210, 212, 215, 213 and 211 are folded inward, the middle panel 215 forms a left side wall of the carrier. Further, FIG. 8 shows that as the portfolio carrier 9 closes, the right-side panels 26, 28, 214, 29 and 27 fold accordion-like onto one another, and the left-side panels 210, 212, 215, 213 and 211 fold accordion-like on one another. The magnets 236, 237 in the first handle portion confront the magnets 238, 239 in the confronting second handle portion and, thus, provide a secure closure system for the portfolio carrier.

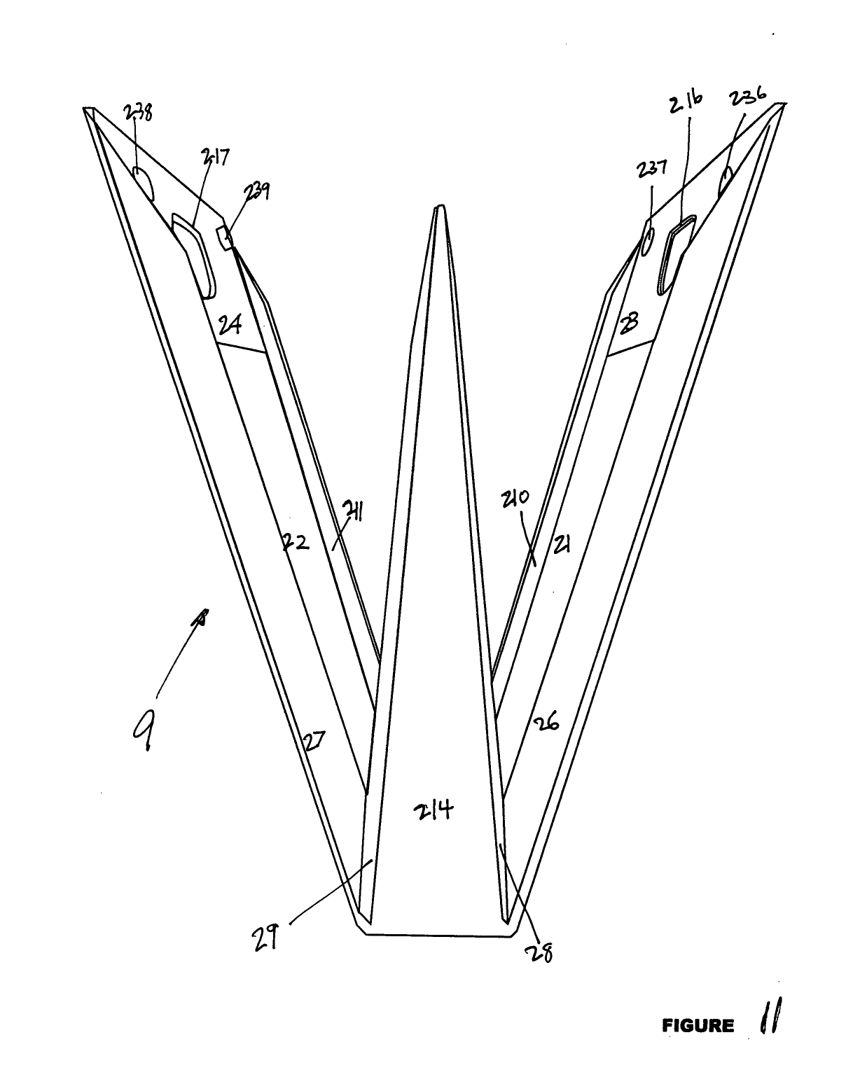

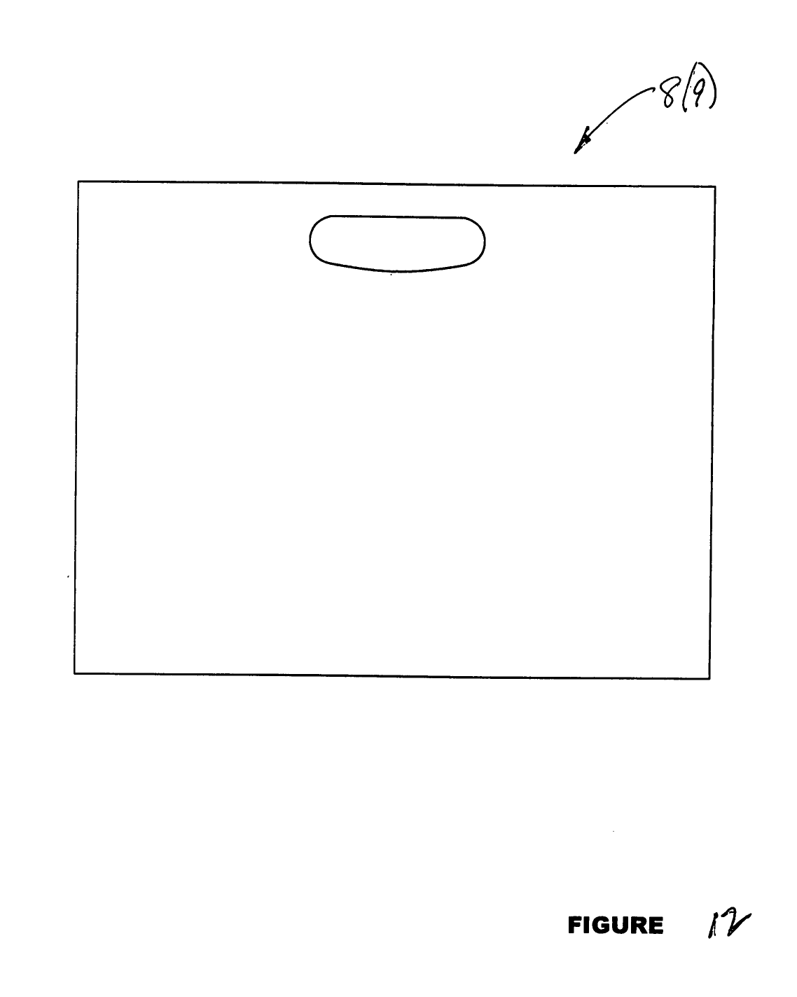

FIG. 11 is a side view of the portfolio carrier 9 in a partially open position, and FIG. 9 is a perspective view of the carrier when in a fully closed position. FIG. 12 is a front elevation view of either of the portfolio carriers 8, 9 when in the closed position.

### EXAMPLE

Either one of the portfolio carriers 8, 9 may be constructed as described below. While reference numerals identifying parts the carrier 8 of FIG. 1 are used for purposes of explanation, the example applies as well to parts of the carrier 9 of FIG. 4 when the first digit of the reference numeral is changed from a “1” to a “2”.

Sheet Folding Procedure

A preferred sequence for manual folding of the sheet material 10 along each of the score lines shown and described herein, proceeds as follows.

Starting from the right hand side of the sheet material 10 in FIG. 1 (because the folding process is symmetrical with respect to the left and the right hand sides of the sheet material 10, the process may optionally begin from the left hand side of the material):

1. Mount the magnets 136-139 (e.g, with an adhesive) on the panels 13 and 14. Place a hand under panel 13 and gently urge the panel inward toward the center of the sheet material 10 thus causing the panel 13 to fold about the parallel score lines 120, 121. Release the panel 13.

2. Place a hand under panel 14 and gently urge the panel inward toward the center of the sheet material 10 thereby causing the panel to fold about the score lines 122 and 123. Release the panel 14.

3. Place an adhesive, e.g., a resin glue, on panel 13 and push it against panel 11 to cause the two panels 13, 10 to adhere to one another.

4. Place an adhesive, e.g., a resin glue, on panel 14 and push it against panel 12 to cause the two panels 14, 12 to adhere to one another.

5. Allow time for the glue applied in steps 3 and 4 to dry.

6. Place a hand under the panel 11 and gently urge it the direction of the panel 12 so as to cause panel 11 to fold along score line 134. Allow the panel 11 to lay back flat.

7. Place a hand under the panel 12 and gently urge it in the direction of the panel 11 so as to cause panel 12 to fold along score line 135. Allow the panel 12 to lay back flat.

8. Place a hand under the entire right side of the sheet material 10, and gently fold panels 16, 18, 114, 19 and 17 together along fold line 128 toward the center of the material 10. Allow the panels 16, 18, 114, 19 and 17 to lay back flat.

9. Place a hand under the entire left side of the sheet material 10, and gently fold panels 110, 112, 115, 113 and 111 together along fold line 129 toward the center of the material 10. Allow the panels 110, 112, 115, 113, and 111 to lay back flat.

10. Place a hand under panel 11 and gently urge it in the direction of panel 12 so that the panel 11 folds about the score line 134. Place a hand beneath the panels 16, 18, 114, 19 and 17 at the right side of the sheet material 10, and lift these panels to form a right angle with the panels 11, 15, and 12. Gently urge the material 10 in the vicinity of the score line 124 toward the center of the material, so that the panels 16, 18, and 114 fold about the score lines 124 and 126. Allow the material 10 to lay back flat.

11. Place a hand under panel 12 and gently urge it in the direction of panel 11 so that the panel 12 folds about the score line 135. Place a hand beneath the panels 16, 18, 114, 19 and 17 at the right side of the sheet material 10, and lift these panels to form a right angle with the panels 11, 15 and 12. Gently urge the material 10 in the vicinity of the score line 125 toward the center of the material, so that the panels 17, 19, and 114 fold about the score lines 125 and 127. Allow the sheet material 10 to lay back flat.

12. Rotate the sheet material 10 by 180 degrees so that the central panels are oriented, in order from top to bottom, as panels 12, 15 and 11. Place a hand under the panel 12 and gently urge the panel in the direction of panel 11 so that panel 12 folds about the score line 135. Place a hand beneath the panels 111, 113, 115, 112, and 110 (now at the right side of the sheet material 10), and lift these panels to form a right angle with panels 12, 15, and 11. Gently urge the material 10 in the vicinity of the score line 131 toward the center of the material so that the panels 111, 113 and 115 fold about the score lines 131 and 133. Allow the material 10 to lay back flat.

13. Place a hand beneath panel 11 and gently urge it in the direction of panel 12 so that the panel 11 folds about the score line 134. Place a hand beneath the panels 111, 113, 115, 112 and 110 (now at the right side of the material 10), and lift these panels to form a right angle with panels 12, 15 and 11. Gently urge the sheet material 10 in the vicinity of the score line 130 toward the center of the material so that the panels 110, 112 and 115 fold about the score lines 130 and 132. Allow the sheet material 10 to lay back flat.

14. Rotate the sheet material 10 again by 180 degrees to assume its original orientation in FIG. 1. Place both hands under both sides of the material; that is, beneath the panels 16, 18, 114, 19 and 17 at the right side, and beneath the panels 110, 112, 115, 113 and 111 at the left side of the material, and fold both sets of the side panels toward the center of the sheet material 10 using the score lines about which the panels were previously folded. Urge the panel 12 along score line 135 toward the panel 11 which folds about the score line 134, until the opposing magnets 136, 138, and 137, 139, cause their associated handle portions to “snap” together and close the assembled portfolio carrier 8 as shown in FIG. 9.

Materials used to fabricate the inventive portfolio carrier may include:

1. Sheet material 10; paper-fluted corrugate made from three layers of 250 gram weight Kraft paper, i.e., inside paper, fluting, and outside paper.

2. Outside covering (optional) for the panels 11, 12; 110 gram weight specialty paper.

3. Resin glue for lamination.

4. Closure devices 136, 137, 138, 139; Iron magnets—18 mm by 5 mm (approx.)

Packaging for shipping, display and/or sale of the portfolio carrier:

1. PE shrinkwrap

2. Paper cartons

Manufacture:

1. Enter die specifications and dimensions of the portfolio carrier into a computer.

2. Convert the carrier pattern into a wood and metal die.

3. Print the outside 110 gram outside covering paper with desired graphics or a relief design as indicated by order specifications.

4. Flood coat or print the inner layer of the corrugate sheet material 10 with color to order specifications.

5. Laminate the sheet material 10 and the printed outside covering paper together under pressure using, e.g. a hydraulic rolling machine and a resin glue.

6. Cut the laminated material obtained in step 5, above, into sheets.

7. Bring the laminated sheets to die cutting machines where the desired patterns are prepared.

8. Cut and score the sheets on the die cutting machines to obtain the desired dimensions and score lines on each sheet, per the order specification.

9. Stack the die cut and scored sheets, and bring them to tables for folding.

10. Insert the magnets at the appropriate locations using, e.g., a jig and a hammer.

11. Fold each sheet to the finished shape of the portfolio carrier using, e.g., the above folding procedure, and send the finished portfolio carrier to a shrink wrap machine section.

12. Use PE sheeting to surround the finished carrier, and run through a heat chamber to form/shrink the sheeting about the portfolio carrier.

13. Label the packaged portfolio carriers, e.g., attach a label on the outside of the surrounding PE sheeting.

14. Pack the finished/packaged portfolio carriers in shipping cartons, and deliver to the customer or an outside shipping company.

It will be appreciated that due to the manner in which the sheet material 10 (or 20) is cut and scored, the material can be easily folded following the above procedure to construct the finished portfolio carrier 8 (or 9) without applying undue force or otherwise destroying the material. Once constructed, a user can insert papers, files and other objects in one or more interior compartments of the carrier, and then close the carrier by way of the magnets or other closure devices provided on the confronting handle portions. The magnetic closure devices disclosed herein are only one of several possible closure mechanisms and others such as, for example, button snaps, strips of hook and loop material, zippers, or the like may be used as well.

As noted in the above example, the outside surfaces of the major panels 11, 12 (or 21, 22) of the carrier may be covered with a pre-printed sheet of paper or other material for displaying attractive patterns and/or designs in a virtually unlimited range of colors. The covering sheet may also be custom designed by a user, for example, by communicating files to and from a supplier's or vendor's website on the Internet. The covering sheet may comprise paper, natural or man-made materials, fabrics or plastics. Also, because the inventive carrier may contain a variety of objects in addition to papers or files, it can serve as an attractive product for the fashion and accessory industries.

For example, as a complement to existing women's handbags, clutches and the like, the inventive carrier may be covered with virtually any natural or manmade material or fabric. Further, the carrier can act as a vehicle for advertising text and images. For example, the covering sheet can carry an advertisement that is pre-printed using state-of-the art lithographic processes on high quality paper, thus providing the advertising/premium field with a new media option.

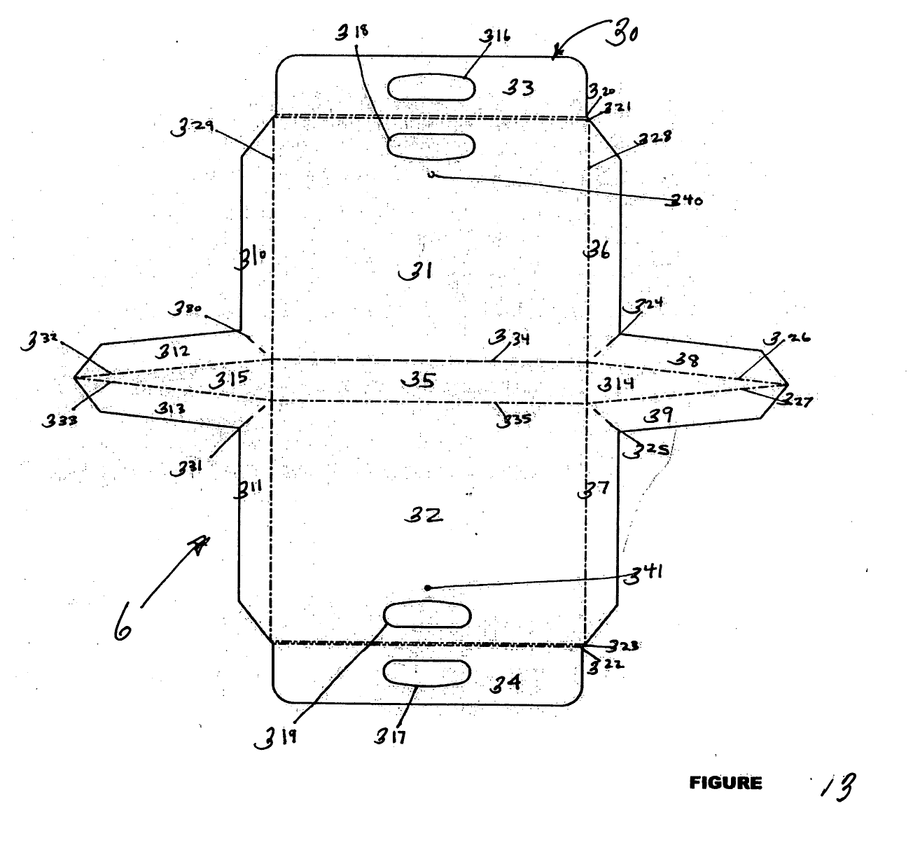

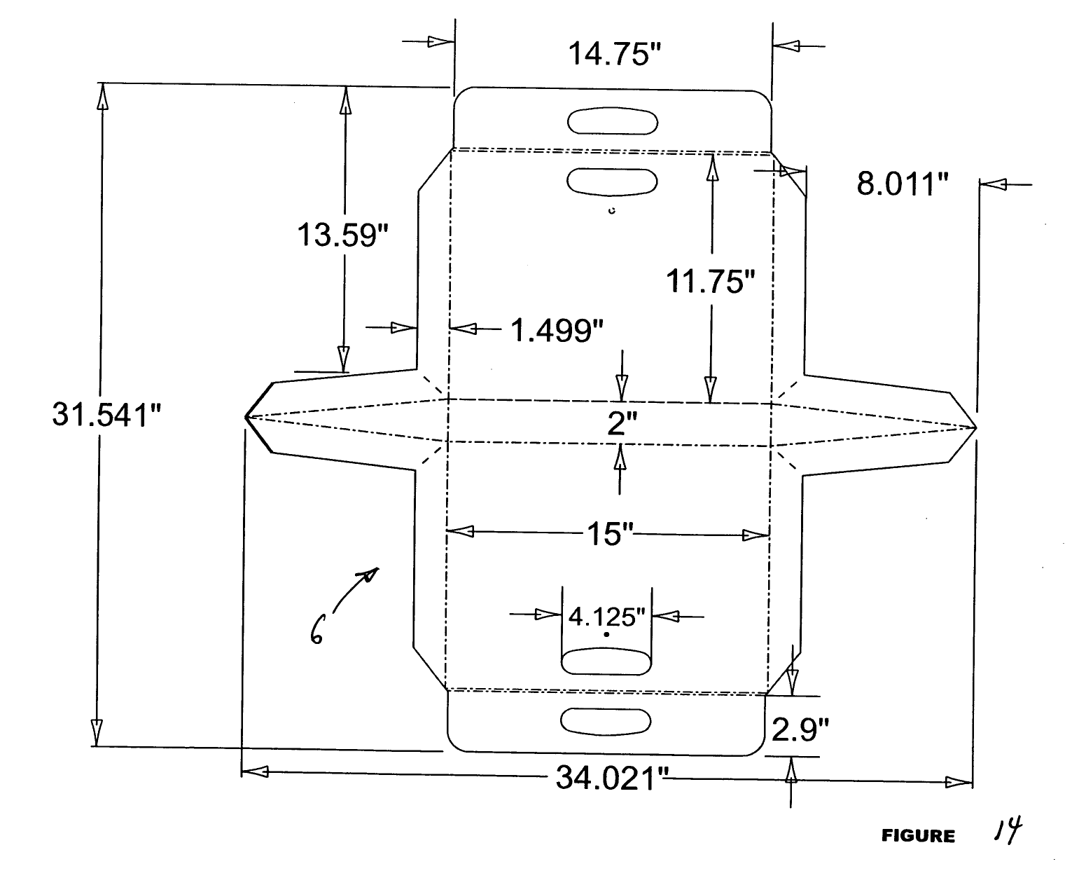

FIG. 13 shows a third embodiment of a portfolio carrier 6 according to the invention. A sheet material 30, for example, a sturdy paper corrugate, is cut to form outside edges and handle openings 316, 318 and 317, 319 in the material, as shown in dark lines in FIG. 13. Score lines, shown in dashed lines in the drawing, are also formed in the sheet material 30. The score lines serve to define various panels and handle portions of the portfolio carrier 6, and an interior compartment that is dimensioned and arranged to contain an accordion folder. FIG. 14 shows an example of typical dimensions (in inches) defining the edges of the cut sheet material 30 and the score lines so that the portfolio carrier 6 can contain an accordion folder for letter size papers and files.

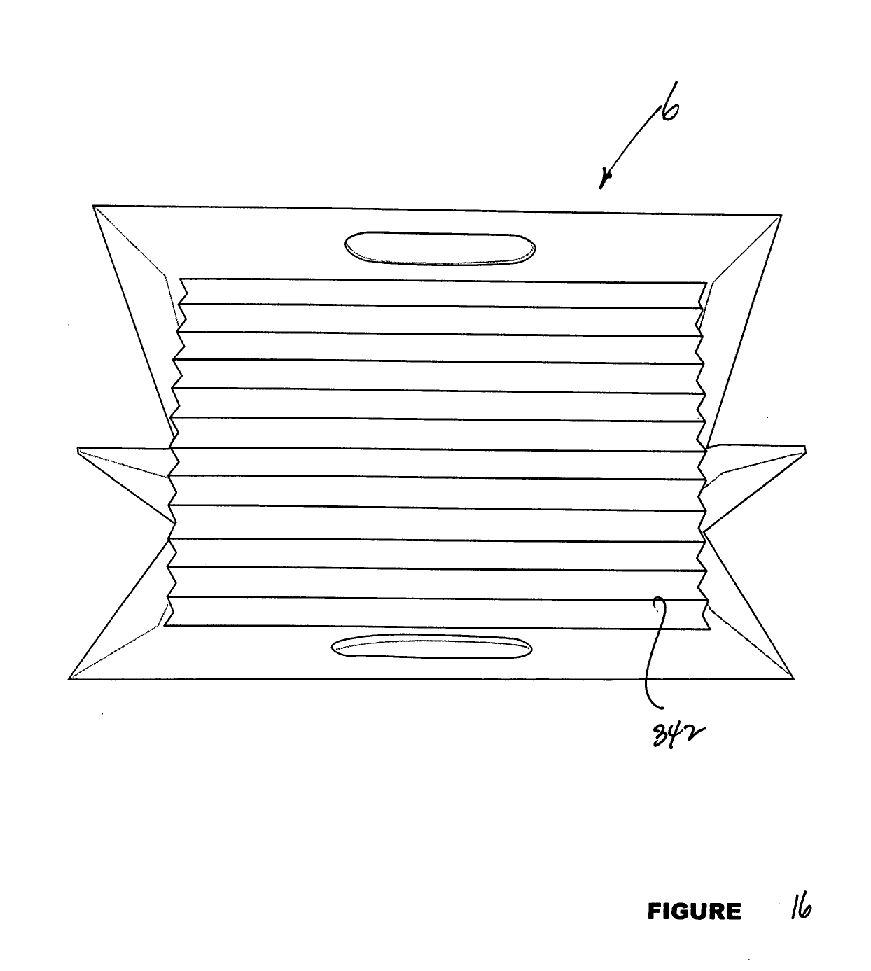

As shown in FIGS. 13, 15 and 16, a central interior compartment dimensioned for housing, for example, a standard letter-sized accordion folder 342 is formed by folding the five right side panels 36, 38, 314, 39, and 37 inward about their associated score lines 324, 325, 326, 327 and 328 toward the central panels 31, 32; and by folding the five left side panels 310, 312, 315, 313, and 311 inward about their associated score lines 329, 330, 331, 332 and 333 toward the central panels. When folded as described, free edges of the right and the left side panels are displaced inward and serve to contain the accordion folder 342 as seen in FIG. 16.

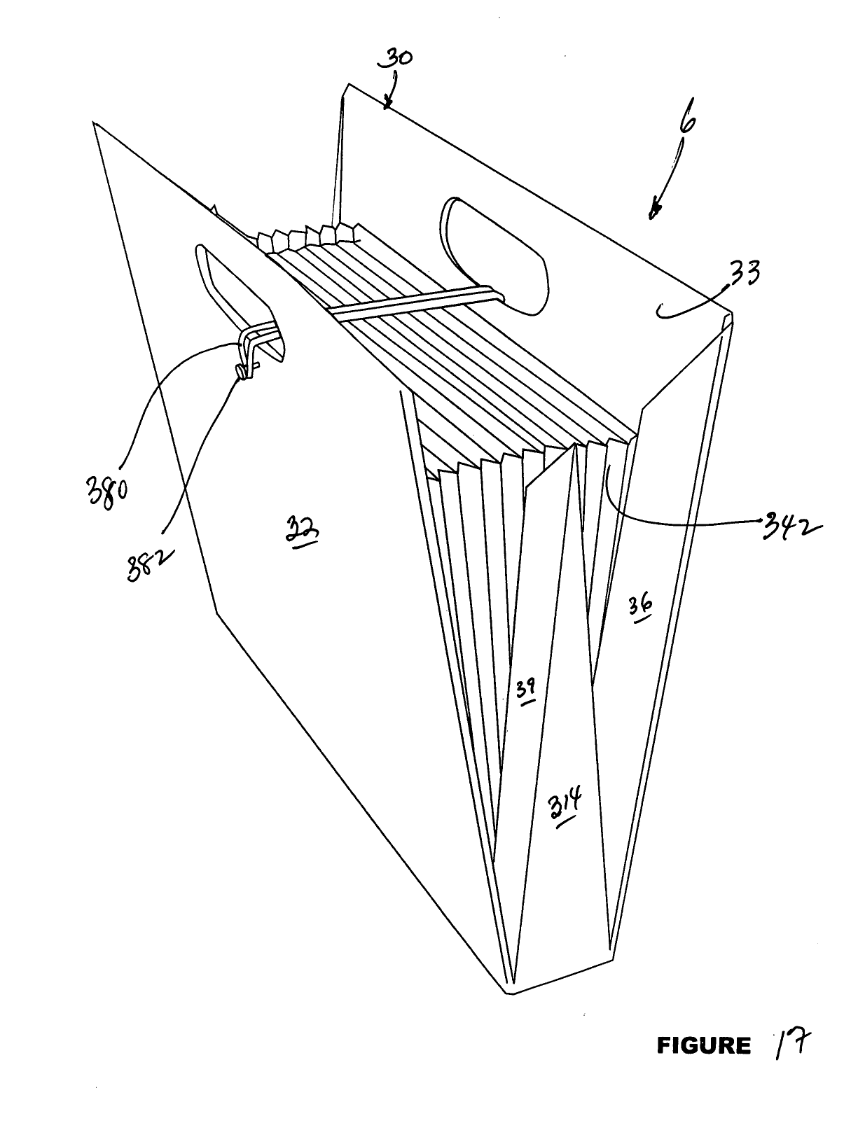

A hole 340 is die-cut or otherwise formed in the central panel 31 for receiving an elastic cord 380 (see FIG. 17) one end of which engages the panel 31 at the hole 340 (e.g., via a knot). The opposite end of the cord 380 is routed through the handle openings of the portfolio carrier 6 and is looped about an exterior stud or post 382 anchored in a hole 341 formed in the central panel 32, to provide a secure closure system for the carrier once papers or files are inserted in compartments of the accordion folder 342.

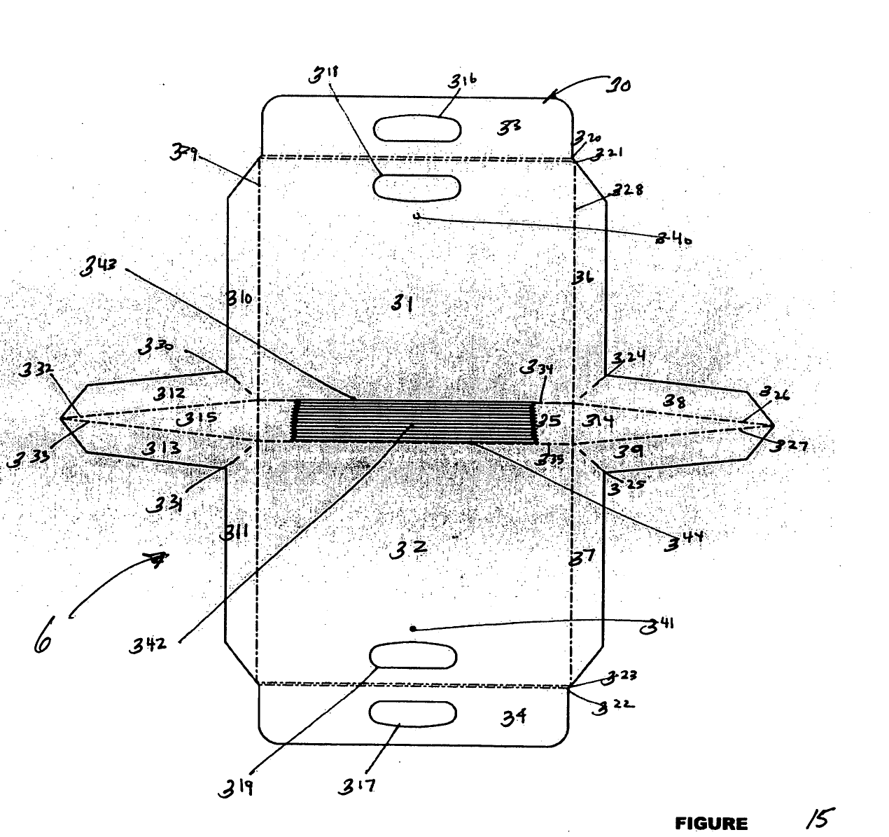

FIG. 15 also depicts the application of adhesives 343, 344 such as, e.g., deposits of glue, double-side adhesive tape or the like, on the outer major surfaces of the accordion folder 342. After a bottom wall of the folder 342 is seated on a separator panel 35 defined on the sheet material 30, the central panels 31, 32 are folded to lie flush against the confronting major surfaces of the folder so that the panels 31, 32 will permanently adhere to the folder as seen in FIG. 16.

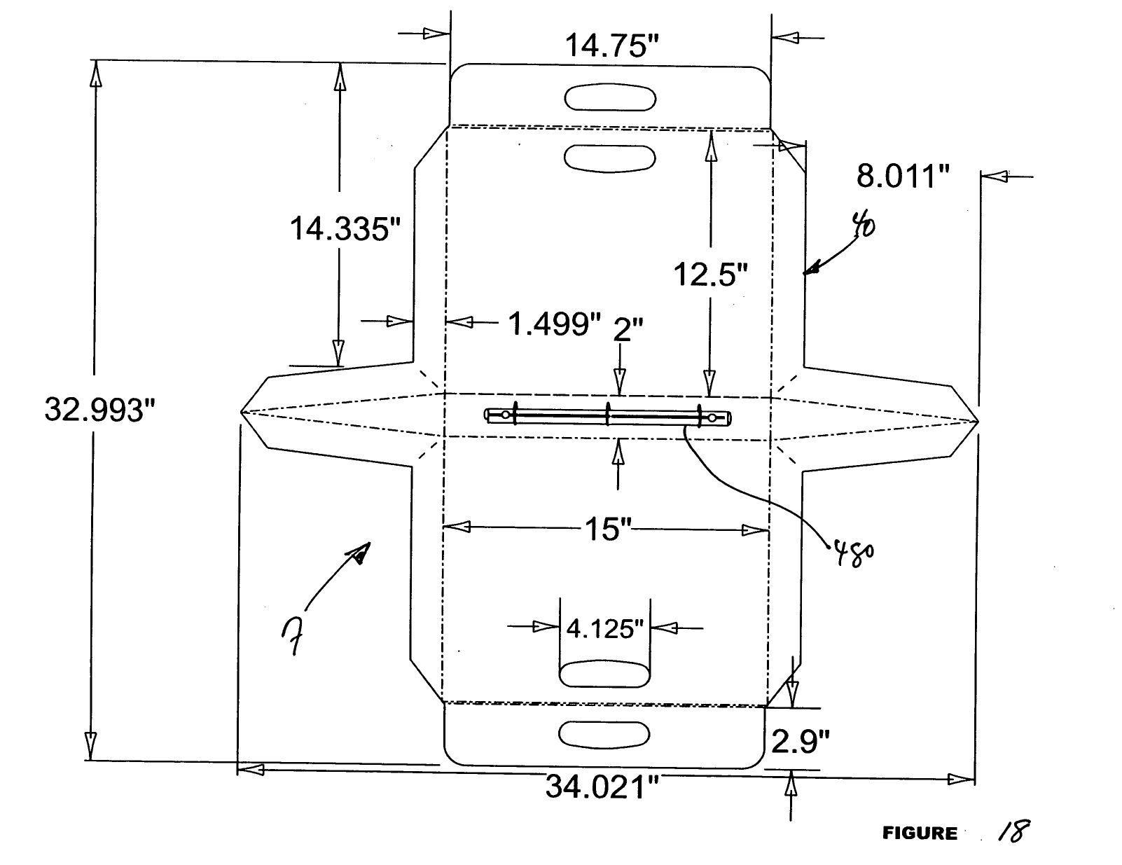

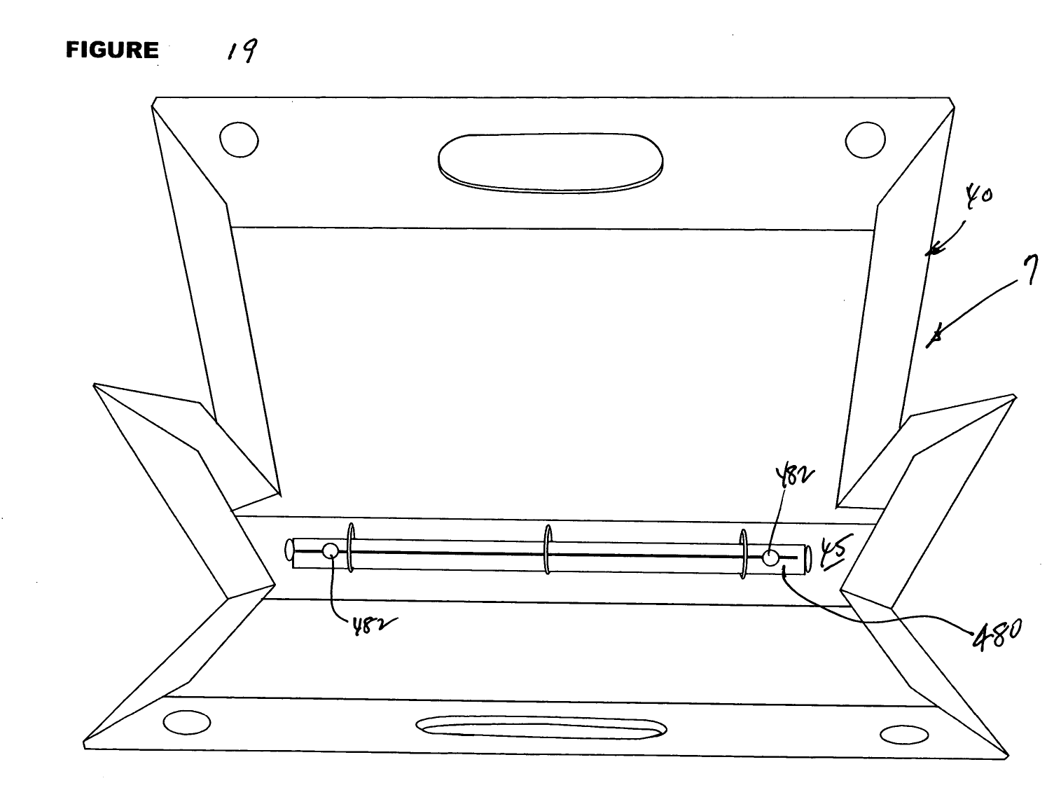

FIGS. 18 and 19 illustrate a fourth embodiment of a portfolio carrier 7 according to the invention. In FIG. 18, a sheet material 40, for example, a sturdy paper corrugate, is cut to form outside edges and handle openings in the material as shown in dark lines in FIG. 18. Score lines, shown in dashed lines in the drawing, are also formed in the sheet material 40. The score lines serve to define various panels and handle portions of the portfolio carrier 7, and an interior compartment that is dimensioned and arranged to contain a ring binder strip 480 and papers that may be secured by rings of the strip 480. Typical dimensions (in inches) are shown for the edges and score lines on the sheet material 40 in FIG. 18 so that the finished portfolio carrier 7 can contain a standard letter-sized three-ring binder strip 480 together with letter size papers bound by the rings of the strip.

FIG. 19 shows the portfolio carrier 7 in a partially open position, with the ring binder strip 480 seated and secured (e.g., by rivets 482) on the separator panel 45 defined by the score lines on the carrier sheet material 40.

While the foregoing describes and illustrates preferred embodiments of the invention, all modifications and equivalents that would be apparent to those skilled in the art are intended to lie within the spirit and scope of the invention as defined by the following claims.

1. A portfolio carrier, comprising:
a sheet material cut to have a central portion, a left side portion and a right side portion of the material;
the sheet material has a number of score lines wherein a first score line defines a boundary between the central portion and the right side portion of the material, and a second score line defines a boundary between the central portion and the left side portion of the material;
score lines in the central portion of the sheet material define a pair of major panels and a separator panel extending between the pair of major panels, score lines in the right side portion of the sheet material define five contiguous right side panels, and score lines in the left side portion of the sheet material define five contiguous left side panels;
the score lines are dimensioned and configured so that the portfolio carrier is formed by (i) urging the pair of major panels in the central portion of the sheet material toward one another about corresponding score lines defining opposite sides of the separator panel, (ii) urging the right side portion of the material toward the central portion of the material about the first score line, and folding the right side panels over one another so that a middle one of the right side panels forms a right side wall of the carrier, and remaining right side panels extend inward from the right side wall partially to define one or more interior compartments of the carrier, and (iii) urging the left side portion of the material toward the central portion of the material about the second score line, and folding the left side panels over one another so that a middle one of the left side panels forms a left side wall of the carrier, and remaining left side panels extend inward from the left side wall partially to define the interior compartments of the carrier.

2. A portfolio carrier according to claim 1, wherein the sheet material is cut and has score lines that define handle portion panels extending from ends of the major panels opposite the separator panel.

3. A portfolio carrier according to claim 2, wherein the handle portion panels are folded about their associated score lines and adhered to a corresponding major panel.

4. A portfolio carrier according to claim 2, including magnets associated with the handle portion panels and arranged for providing a closure system for the carrier.

5. A portfolio carrier according to claim 1, wherein the sheet material comprises paper-fluted corrugate.

6. A portfolio carrier according to claim 1, including a pattern or design placed on an outside surface of at least one of the major panels.

7. A portfolio carrier according to claim 6, including a cover sheet adhered on the outside surface of the major panel for displaying the pattern or design.

8. A portfolio carrier according to claim 1, including an accordion folder fixed inside the carrier.

9. A portfolio carrier according to claim 1, including a ring binder strip fixed inside the carrier.
